(19) United States
(12) Patent Application Publication
(10) Pub. No.: US 2005/0144649 A1
(43) Pub. Date: Jun. 30, 2005

(54) Apparatus and method for reduction of wireless links noise injection to a DOCSIS cable modem service

(76) Inventors: James Bertonis, Los Gatos, CA (US); William Fujimoto, San Jose, CA (US)

Correspondence Address: GLENN PATENT GROUP, 3475 EDISON WAY, SUITE L, MENLO PARK, CA, 94025, US

(21) Appl. No.: 10/996,625

(22) Filed: Nov. 23, 2004

Related U.S. Application Data
(60) Provisional application No. 60/525,365, filed on Nov. 25, 2003.

(51) Int. Cl. H04N 7/173; G08C 15/00; H04L 12/26; G06F 11/00; H04J 3/14; H04J 1/16; H04L 1/00

(52) U.S. Cl. 725/124; 370/317; 370/332; 725/111

(57) ABSTRACT

A DOCSIS cable modem service can be extended by providing wireless links that connect users that are beyond the physical reach of the system. This may require that the downstream data are transferred over a wireless link to a remote subscriber radio frequency (RF) unit connected to a cable modem that provides the downstream data to the subscriber. Similarly, upstream data are sent from the subscriber cable modem over the wireless link to the wireless hub transceiver, where such data are inserted back to the distribution coax cable. This insertion causes the injection of noise into the DOCSIS cable modem system. Connecting a plurality of such devices can cause noise beyond the system limitations. By using a burst detect system, the RF receiver portion of the device is connected to the DOCSIS cable only when injecting data upstream, thereby reducing the overall noise injection.

### CROSS REFERENCE TO RELATED APPLICATIONS

This application claims priority from U.S. provisional patent application Ser. No. 60/525,365, filed on Nov. 25, 2003, which application is incorporated herein in its entirety by this reference thereto.

### BACKGROUND OF THE INVENTION

1. Technical Field

The invention relates generally to noise reduction in DOCSIS cable modem services more specifically, to the invention related to the reduction of noise injection for upstream data transmission from a wireless link to a DOCSIS cable modem service system.

2. Discussion of the Prior Art

The delivery of data using a cable television (CATV) system has become common in residential areas where CATV is commonly available. The data are delivered both downstream and upstream using available channels and/or frequencies. Because providers of CATV expect to deliver additional services, such as data for Internet connectivity, there is an interest to serve as large as possible number of clients. However, it is not always possible to provide a direct connection to each location.

In U.S. patent application Ser. No. 10/463,483, titled “AN APPARATUS AND METHOD FOR EXTENDING DOCSIS CABLE MODEM SERVICE OVER WIRELESS LINKS” (hereinafter “the 483 Application”), assigned to a common assignee of this application, which is hereby incorporated by reference for all that it contains, a wireless connectivity to a CATV data delivery system is shown.

FIG. 1 illustrates a modified CATV distribution system 100 that uses wireless communication to deliver data to shopping mall 120. A splitter unit (SU) 310 is connected to the distribution coax cable 115 which, in turn, couples to subscribers 110, in some cases via cable modems 117, delivers downstream data to a wireless hub transceiver (WHT) 300. The WHT 300 provides the SU 310 with upstream data. The WHT 300 uses an antenna 230 to communicate with an antenna 240, as explained in more detail below. A receiving unit comprised of an antenna 240 and a subscriber radio frequency unit (SRFU) 242 is described in detail in U.S. patent application Ser. No. 10/282,533, titled SYSTEM AND METHOD FOR WIRELESS CABLE DATA TRANSMISSION assigned to a common assignee of this application and hereby incorporated by reference for all that it contains. The SRFU 242 is further connected to a cable modem, thereby enabling a subscriber in the mall 120 to receive data communication through extension of the Data Over Cable Service Interface Specifications (DOCSIS) cable modem service over a wireless link. A more detailed description of an exemplary SRFU 242 is provided below. A person skilled in the art may easily modify such a receiving unit to support a 64 quadrature amplitude modulation (QAM). The SU 310 provides upstream and downstream connectivity to the WHT 300. In one embodiment, the SU 310 further provides the AC power required for the operation of the WHT 300.

The connection of a WHT 300 unit naturally causes the injection of upstream noise into the CATV system. The noise levels allowed on a CATV system, i.e. a signal-to-noise ratio (SNR), is on the order of 30 deciBels (dB). A WHT 300 unit would require a signal to have a challenging 35 dB SNR or higher to be transparent to the CATV system. In a system requiring the placement of a plurality of WHTs 300, the noise injection in the system would be beyond that allowed by CATV system specifications. Prior art solutions favor the use of switching units on and off or, in other words, connecting and disconnecting the units. This, however, creates spectral spreading because high speed switching transients occur, rendering them at least as problematic. The injection of an unacceptable level of noise by a receiver happens whenever a user attempts to optimize the wireless link and therefore impairs the signal-to-noise ratio of the cable upstream systems. A person skilled-in-the-art would realize that connecting more wireless extension hubs would make the noise situation even worse.

It would be therefore advantageous to provide an apparatus and a method that allows such a CATV system to operate in the presence of a plurality of wireless devices connected to the system, and particularly to a plurality of WHT 300 units connected to that system.

### SUMMARY OF THE INVENTION

A DOCSIS cable modem service can be extended by providing wireless links that connect users that are beyond the physical reach of the system. This may require that the downstream data are transferred over a wireless link to a remote subscriber radio frequency (RF) unit which is connected to a cable modem that provides the downstream data to the subscriber. Similarly, upstream data are sent from the subscriber cable modem over the wireless link to the wireless hub transceiver, where such data are inserted back to the distribution coax cable. This insertion causes the injection of noise into the DOCSIS cable modem system. Connecting a plurality of such devices can cause noise beyond the system limitations. By using a burst detect system the RF receiver portion of the device is connected to the DOCSIS cable only when injecting data upstream thereby reducing the overall noise injection.

### BRIEF DESCRIPTION OF THE DRAWINGS

FIG. 1 is a schematic diagram showing distribution of CATV coax cables in a residential area with a wireless extension;

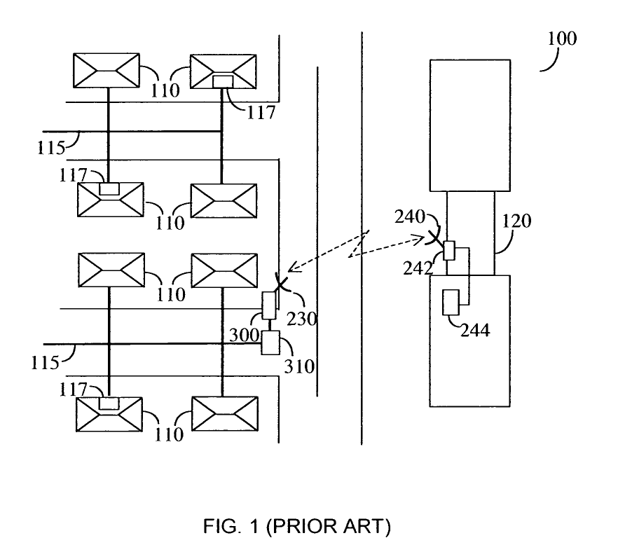

FIG. 2 is a schematic block diagram showing a wireless hub transceiver connected to a distribution coax cable in a CATV system;

FIG. 3 is a schematic block diagram showing a variable gain upstream receiver;

FIG. 4 is a flowchart showing the steps for the control of noise injection into a CATV system;

FIG. 5 is a schematic block diagram showing circuit designed in accordance with the invention; and

FIG. 6 is a schematic block diagram showing a circuit having a noise-floor sampler in accordance with the invention.

### DETAILED DESCRIPTION OF THE INVENTION

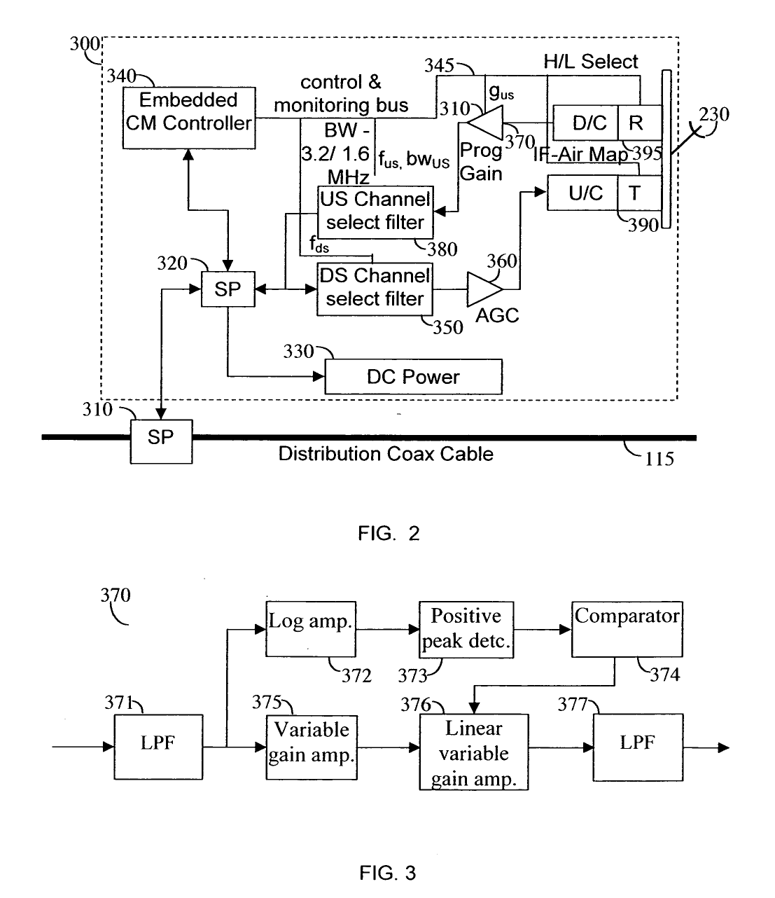

Reference is now made to FIG. 2 which is a detailed block diagram of a wireless hub transceiver (WHIT) 300 this is connected through a splitter unit (SU) 310 to a distribution coax cable 115. The WHT 300 comprises a splitter 320, an embedded cable modem controller 340, a downstream channel unit 350, an automatic gain control 360, a programmable gain 310, an upstream channel unit 380, an up-converter transmitter unit 390, and a down-converter receiver unit 395. Both the up-converter and down-converter are connected to an antenna 230. A DC power unit 330 is optionally connected to a splitter 320 if it is possible to provide AC power from the distribution coax cable 115.

Operation of the WHT 300 is performed under the control of embedded cable modem controller 340. Various control signals are delivered to components of the WHT 300. The upstream channel unit is controlled for both the center's Data Over Cable Service Interface Specifications (DOCSIS) upstream frequency (fᵤₛ) for wireless operation, as well as for the upstream DOCSIS bandwidth (bwᵤₛ) which is selective at doubling steps starting from 200 Hz up to 3.2 MHZ, or 6.4 MHz in the case of DOCSIS 2.0. DOCSIS carriers support frequencies of 50-860 MHz for downstream communication and 5-48 MHz for upstream communication. A programmable gain unit (PGU) 370 is connected between the down-converter receiver unit 395 and the upstream channel unit 380. The gain is controlled by means of an embedded cable modem controller 395 by providing the upstream gain (gus) parameter. A detailed description of this operation is provided in the '483 application.

The programmable gain unit 370 is a source of noise that is injected back into the cable modem cables, thus reducing the signal-to-noise ratio (SNR) required for proper operation of the system. Moreover, connecting a plurality of WHT 300 units to distribution coax cable 115 results in levels of noise that are unacceptable. The inventors have noted that the data provided using DOCSIS are in bursts and, hence, an upstream receiver sends data only when such a burst occurs. At all other times the system is affected by the noise generated by PGU 370. Further, notably, is the fact that DOCSIS allows bursts of data from a single transmitter at a time (TDMA), such that channel use is effective. Therefore, the inventors have discovered that it would be advantageous to detect the presence of a data burst and enable the PGU 370 to provide data to the CATV system only upon presence of such data.

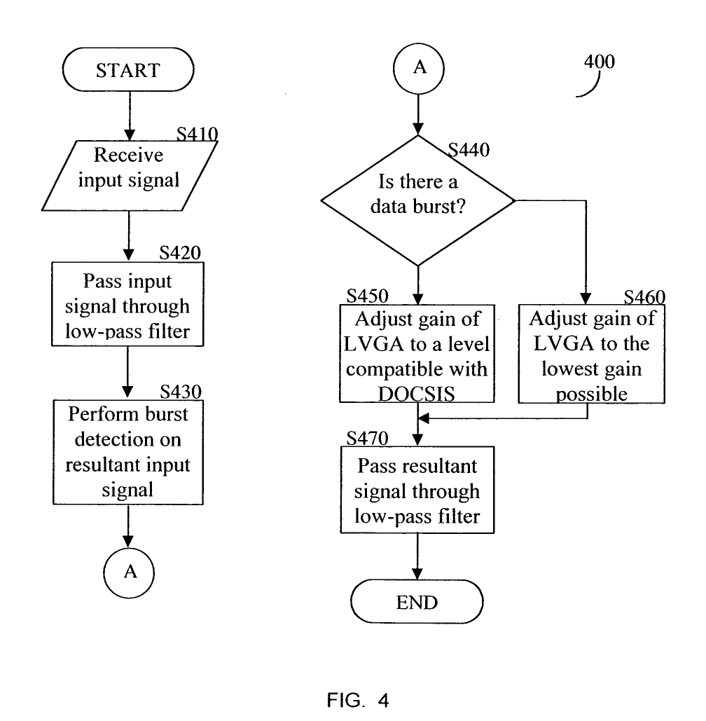

FIG. 3 is a schematic block diagram of a variable gain amplifier 370 of an upstream receiver. An input signal is received at a low pass filter (LPF) 371 and then fed to both a logarithmic amplifier 372 and to a variable gain amplifier 375. The output of the logarithmic amplifier 372 is a logarithmic function of the input signal. Therefore, low signals are essentially amplified more than large signals. The output of the logarithmic amplifier 372 is fed to a positive peak detector 373 that is capable of detecting a peak in the signal. This peak is compared by a comparator 374 to a reference value and, if it exceeds that value, it switches the gain of a linear variable gain amplifier (LVGA) 376. The LVGA 376 receives the signal from the variable gain amplifier 375 that amplifies the input signal to the desired level of operation. The LVGA 375 changes its gain quickly based on a control, theoretically in the range of minus infinity dB to infinity dB, or for practical purposes from a few minus tens of negative dB to a few tens of positive dB. For example, an acceptable range is −70 dB to 14 dB. When the burst detection path, i.e. the logarithmic amplifier 372, the positive peak detector 373, and comparator 374, provides an indication that a data burst is in progress, the gain of the LVGA 376 is switched from the maximum negative dB value to the maximum positive dB value. This means that only a very small, if any, amount of noise is added when there is no data burst to be transferred because the level of amplification is small. However, when there is a data burst, the amplification is increased as may be required to provide a signal per the specifications for the subject CATV cable system. The resultant signal is transferred through a low pass filter (LPF) 377 to ensure that no high frequency signals get through to the CATV cable system.

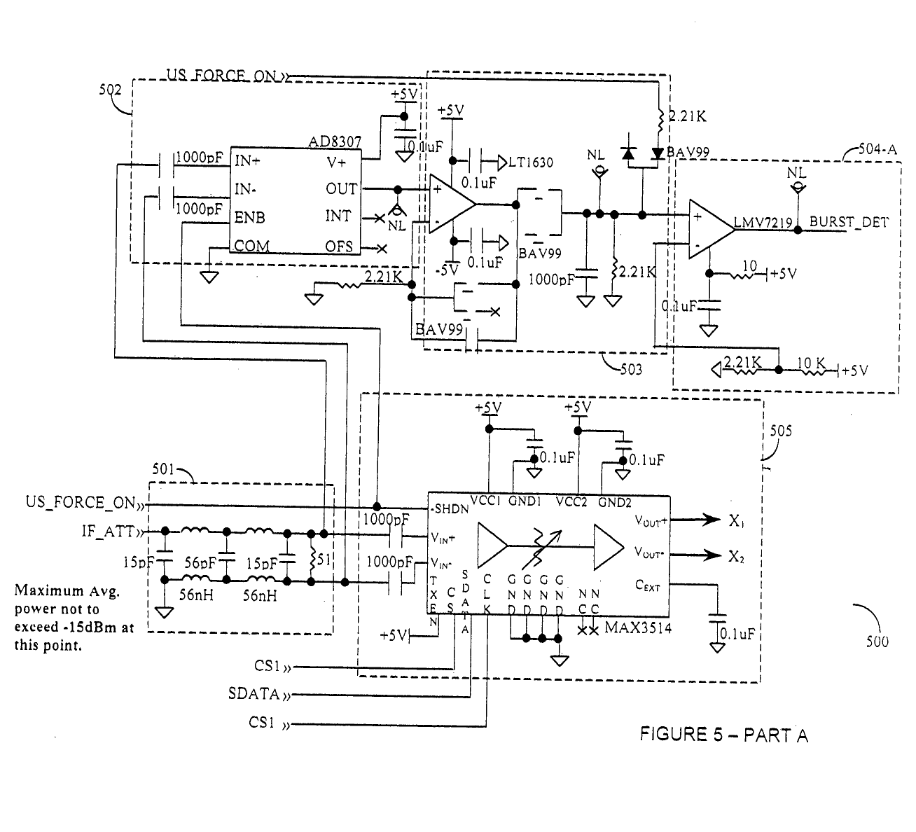

Reference is now made to FIG. 4 which is an exemplary and non-limiting flow chart 400 of a method for the purpose of reducing noise injection during bursts of upstream data into a CATV cable system. In step S410 an input signal is received. Specifically, this is an upstream data stream received from a receiver, such as the WHT 300. In step S420 a channel bandpass filter (CBPF) is applied on the incoming signal, allowing only a signal in the channel to trigger the burst detect. In step S430, a burst detection is performed, i.e. it detects whether a data burst actually exists. As explained above, under the DOCSIS specification a receiver receives data in burst of transmission and is on-line only during these burst periods, and otherwise should not interfere with the ability of other transmitters to send data bursts. In step S440, it is checked whether a data burst was actually received. If the answer is positive, then execution continues with step S450 where the gain, for example the gain of the LVGA 376, is adjusted to provide the maximum allowable amplification to the signal. Otherwise, if the answer is negative, the execution continues with step S460 where the gain, for example the gain of the LVGA 376, is adjusted to provide the minimum allowable amplification to the signal. By using one of these two gain settings, it is possible to provide the signal to a CATV cable system with the minimum noise level, thereby maintaining the required SNR of the system. In step S470, a low pass filter is applied to the resultant signal to avoid transmission of any high frequencies that may have been added to the signal during the processing.

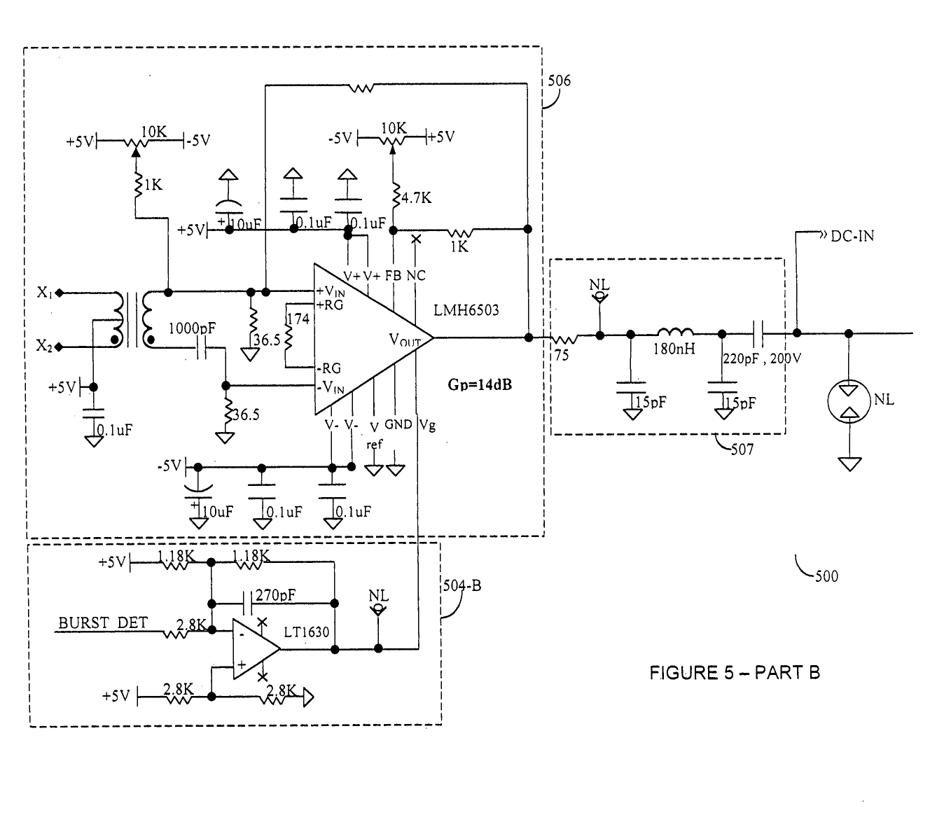

Referring now to FIG. 5, an exemplary and non-limiting schematic of a circuit 500 comprised in accordance with the disclosed invention is shown. For clarity purposes, certain components of the circuit are boxed to indicate their functionality in respect to the block diagram of FIG. 3, discussed above. The low pass filters 501 and 507 correspond to LPF 371 and LPF 377, respectively. Both are comprised of passive components, such as resistors, capacitors, and inductors. The logarithmic amplifier 502 corresponds to the logarithmic amplifier 372, and is comprised of a standard logarithmic amplifier, such as the Analog Devices' AD8307 component. The peak detector 503 corresponds to the peak detector 373, and comprises an operational amplifier, diodes, and a passive integrator in the form of, for example, a 1,000 picoFarad capacitor. This comparator 504 appears in the schematic of the circuit in two parts, i.e. 504-A and 504-B, which together correspond to the comparator 374. Specifically the circuit 504-B shapes the signal as it goes through the linear variable gain amplifier (LVGA) 506, in a fashion that is compatible with the burst width of a DOCSIS upstream signal. The variable gain amplifier 505 corresponds to the variable gain amplifier 375, and may be implemented using an amplifier, such as Maxim's MAX3514 CATV upstream amplifier. The LVGA 506 corresponds to the LVGA 376, and may be implemented through the use of National Semiconductor's LMH6503 variable gain amplifier.

In another embodiment of the invention it may be desirable to compensate for environmental changes, such as temperature, and its effect on system gain. A person skilled in the art would note that noise levels in a system, especially in a system exposed to the elements, is at least affected by the ambient temperature. As a result, the system noise levels may increase or decrease. For this purpose an analog-to-digital converter (ADC) is used as a noise floor sampler to sample the noise floor levels over a period of time, for example every 10 milliseconds, which corresponds to a rate of 100 samples per second. The samples are averaged over a fixed number of samples, such as 64, and the average is used as the current base noise level of the system. Such a sampling occurs while there is no other signal in the system, i.e. in between bursts. After the digital processing, the result is then sent to a digital-to-analog converter (DAC) such as TLV5637, shown as U26 of block 504-A, and then applied to the comparator 374.

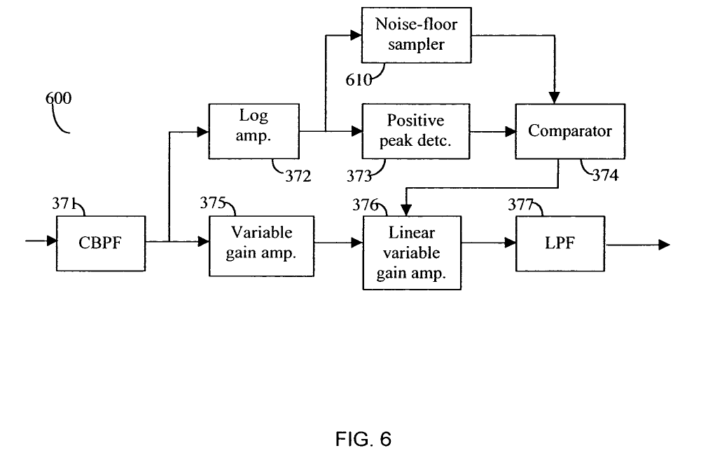

Reference is now made to FIG. 6, which is an exemplary and non-limiting schematic diagram 600 of a circuit having a noise floor sampler 610. The noise-floor sampler 610 samples the noise-floor while no burst is present. The output of noise-floor 610 is connected to the comparator 374 in lieu of the reference voltage discussed in connection with FIG. 3 above. This allows the comparator to adjust itself in response to changes in the noise-floor that result from the environment in which the circuit is placed, for example, in response to changes in temperature.

The values in the text and figures are exemplary only and are not meant to limit the invention. Although the invention has been described herein with reference to certain preferred embodiments, one skilled in the art will readily appreciate that other applications may be substituted for those set forth herein without departing from the spirit and scope of the present invention. Accordingly, the invention should only be limited by the claims included below.

1. An apparatus for reducing noise injection from a wireless device that is configured to insert upstream data to a DOCSIS cable modem, comprising:
a variable gain amplifier (VGA) for maintaining an input signal provided to said DOCSIS cable modem at a level that is sufficient for injection to said DOCSIS cable modem;
a burst detector for detecting when an upstream data burst from said wireless device is present; and
a linear variable gain amplifier (LVGA) connected to said VGA, said LGA operating under control of said burst detector to inject to said DOCSIS cable modem when said data are detected by said burst detector and to disconnect said apparatus from said DOCSIS cable modem when no upstream data are available.

2. The apparatus of claim 1, said apparatus comprising an integrated circuit.

3. The apparatus of claim 1, further comprising:
temperature compensation means.

4. The apparatus of claim 1, further comprising:
noise floor sampling means.

5. A method for reducing noise injection from a wireless device that is configured to insert upstream data to a DOCSIS cable modem, comprising the steps of:
detecting an upstream data burst from said wireless device;
adjusting said upstream data signal level to a level that is compatible with levels required by said DOCSIS cable mode;
inserting said adjusted upstream data signal to said DOCSIS cable modem when said upstream data are detected; and
effectively disconnecting said DOCSIS cable modem when said upstream data are not detected.
